(19) United States
(12) Patent Application Publication
(10) Pub. No.: US 2026/0163007 A1
(43) Pub. Date: Jun. 11, 2026

(54) SCALABLE LASER PROCESSING OF VARIOUS METAL NANOPARTICLES AND LITHIOPHOBIC TITANIUM-INCORPORATED CARBON COMPOSITES FOR LITHIUM METAL BATTERIES

(71) Applicants: Samsung SDI Co., Ltd., Yongin-si (KR); Georgia Tech Research Corporation, Atlanta, GA (US)

(72) Inventors: Seung Woo Lee, Atlanta, GA (US); Minsu Kim, Atlanta, GA (US); Kyungmo Kim, Atlanta, GA (US); Hyewon Kang, Atlanta, GA (US); Hoyoung Lee, Cambridge, MA (US); Yong Seok Kim, Cambridge, MA (US); Jungjoon Kim, Cambridge, MA (US); Haemin Paik, Cambridge, MA (US)

(21) Appl. No.: 19/378,239

(22) Filed: Nov. 3, 2025

Related U.S. Application Data
(60) Provisional application No. 63/730,619, filed on Dec. 11, 2024.

(51) Int. Cl. H01M 4/62; H01M 4/02; H01M 10/0525

(52) U.S. Cl. CPC H01M 4/628; H01M 2004/021; H01M 10/0525

(57) ABSTRACT

An interlayer including a silver-free nanocomposite, a matrix, and a binder, a method of making the interlayer, and a lithium metal battery (LMB) including the interlayer are provided. The nanocomposite includes nanoparticles and a carbonaceous material, the nanoparticles include metals, metalloids, alloys thereof, compounds thereof, or suitable combinations thereof, and the matrix includes a bulk carbonaceous material.

### CROSS-REFERENCE TO RELATED APPLICATION

The present application claims priority to and the benefit of U.S. Provisional Patent Application Ser. No. 63/730,619, filed on Dec. 11, 2024, the entire disclosure of which is incorporated herein by reference.

### BACKGROUND

### 1. Field

Embodiments of the present disclosure relate to a metal nanoparticle-carbon composite for use as an anode host in a lithium metal battery and a UV-laser method of making the metal nanoparticle-carbon composite

### 2. Description of the Related Art

Lithium metal batteries (LMBs) including lithium metal anodes (LMAs) are well-suited for electric vehicles (EVs) and portable electronics due to their superior energy density. However, the practical application of LMAs faces several challenges, including low coulombic efficiency (CE), poor cycle stability, thermal runaway, and the risk of fire or explosion. These issues primarily arise from the significant volume changes of the anode and the non-uniform plating and stripping of lithium (Li) during battery operation. This non-uniform deposition leads to dendrite growth, resulting in low CE and eventual battery failure.

The use of an anode host or interlayer composed of silver nanoparticles (AgNPs) and carbon (C) composite films in LMBs has shown promise in promoting more uniform Li growth and ensuring stable Li transport to the anode without reacting with the solid-state electrolyte (SSE). For example, previous efforts to address these challenges included rapid laser irradiation of a mixture of C and Ag precursor to create Ag—C composites.

Despite the promising performance of Ag-containing interlayers, the reliance on Ag is a significant challenge due to its scarcity in the Earth's crust (75 parts per billion). Replacement of AgNPs with other (e.g., non-noble) metal nanoparticles (M-NPs) such as zinc (Zn), aluminum (Al), tin (Sn), and nickel (Ni) has become important, but such efforts have largely been unsuccessful. Additionally, improving Li-ion transport within the composite film presents another significant challenge.

The need exists for simple and scalable methods of manufacturing metal nanoparticle-carbon composite interlayers that promote stable lithium plating for LMBs.

### SUMMARY

One or more embodiments of the present disclosure relate to a nanocomposite interlayer including metal nanoparticles, a lithium metal battery (LMB) battery including the interlayer, a method of manufacturing the interlayer, and a method of operating the LMB.

One or more embodiments of the present disclosure relate to a one-step fast and scalable UV-laser-based method to synthesize non-noble metal nanoparticle composites. The methods incorporate lithiophobic titanium (Ti) into the carbon composite matrix to enhance or improve Li-ion transport

Embodiments of the present disclosure includes metal element suitable to replace Ag and enhance or improve stability and lithium plating efficiency, for example, when combined with Ti-incorporated C composites. This innovative method promises to revolutionize LMB manufacturing by reducing costs, energy requirements, and production time while enhancing performance and safety.

Further features provided by embodiments of the present disclosure will be described herein but are not limited to the following description.

One or more aspects of embodiments of the present disclosure are directed toward an interlayer including a nanocomposite, a matrix, and a binder, the nanocomposite including nanoparticles and a carbonaceous material, the nanoparticles including metals, metalloids, alloys thereof, compounds thereof, or suitable combinations thereof, the nanocomposite being a silver-free nanocomposite, the matrix including a bulk carbonaceous material, and the interlayer being for a lithium metal battery (LMB).

In one or more embodiments, the interlayer is for an anodeless all-solid-state battery (ASSB) or an anodeless all-solid-state lithium metal battery (ASSLMB).

In one or more embodiments, the nanocomposite is a metal nanoparticle carbon (M-C) nanocomposite and the nanoparticles include at least one metal or at least one metal alloy.

In one or more embodiments, the nanoparticles include at least one of aluminum, antimony, bismuth, cobalt, copper, germanium, gold, iron, molybdenum, nickel, platinum, silicon, tellurium, tin, titanium, tungsten, or zinc.

In one or more embodiments, the nanocomposite is a metal nanoparticle titanium-carbon (M-TiC) nanocomposite including titanium and the nanoparticles.

In one or more embodiments, the M-TiC nanocomposite includes a titanium-carbon (TiC) compound, the TiC compound being in the matrix and having Ti—C chemical bonds and lithiophobic properties.

In one or more embodiments, the nanoparticles include a coating, the coating including the TiC compound and surrounding at least a portion of a surface of the nanoparticles.

In one or more embodiments, an average diameter of the nanoparticles is at least about 5 nanometers (nm).

In one or more embodiments, the carbonaceous material includes amorphous carbon, graphite, graphene, reduced graphene oxide, carbon nanotube, or combinations thereof.

In one or more embodiments, the interlayer includes, based on a total weight of the interlayer: about 5 wt % to about 95 wt % of the carbonaceous material; about 0.1 wt % to about 50 wt % of the nanoparticles; and about 0.01 wt % to about 10 wt % of the binder.

In one or more embodiments, a thickness of the interlayer is about 1 micrometer (μm) to about 30 μm.

One or more aspects of embodiments of the present disclosure are directed toward a silver titanium-carbon (Ag—TiC) nanocomposite, a matrix, and a binder, the Ag—TiC nanocomposite including silver nanoparticles, a titanium-carbon (TiC) compound, and a carbonaceous material, the TiC compound having lithiophobic properties, and the interlayer being for a lithium metal battery (LMB).

One or more aspects of embodiments of the present disclosure are directed toward a lithium metal battery including: a positive electrode; a negative electrode current collector; an electrolyte; and an interlayer including the interlayer of the present disclosure and being between the electrolyte and the negative electrode current collector.

One or more aspects of embodiments of the present disclosure are directed toward a method of manufacturing an interlayer including: providing a carbonaceous material, at least one redox active compound, and a binder to form a slurry; applying the slurry to a current collector; and irradiating the slurry and providing a nanocomposite including nanoparticles, the interlayer including the nanocomposite.

In one or more embodiments, the providing of the redox active compound includes at least one compound including a metal, a metalloid, or combinations thereof.

In one or more embodiments, the providing of the redox active compound does not include a silver-containing compound.

In one or more embodiments, the irradiating of the slurry includes laser irradiating the slurry.

In one or more embodiments, the laser irradiating of the slurry includes at least one of: a speed of about 10 millimeter per second (mm/s) to about 1000 mm/s, a repetition rate of about 50,000 Hz to about 500,000 Hz, a spot diameter of about 5 micrometer (μm) to about 85 μm, or a laser energy of about 0.01 microjoule (μJ) to about 100 μJ.

One or more aspects of embodiments of the present disclosure are directed toward a method of operating a lithium metal battery, the method including: providing a lithium metal battery including: a positive electrode including a cathode active material; a negative electrode current collector; a solid-state electrolyte between the positive electrode and the negative electrode current collector; and an interlayer including a silver-free nanocomposite, and charging the lithium metal battery to provide a plated anode.

In one or more embodiments, the method further includes discharging the lithium metal battery to remove the plated anode.

Additional aspects of embodiments will be set forth in part in the description which follows and, in part, will be apparent from the description, or may be learned by practice of the presented embodiments of the disclosure.

### BRIEF DESCRIPTION OF THE DRAWINGS

### [Place Holder for Drawings Executed in Color.]

The preceding and other objects and features of embodiments of the present disclosure will become more apparent to those of ordinary skill in the art by describing example embodiments thereof in more detail with reference to the accompanying drawings. In the drawings:

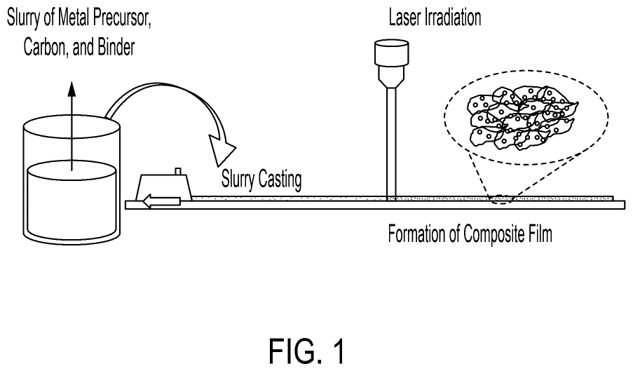

FIG. 1 is a schematic illustration of a method of manufacturing an interlayer including a nanocomposite according to one or more embodiments.

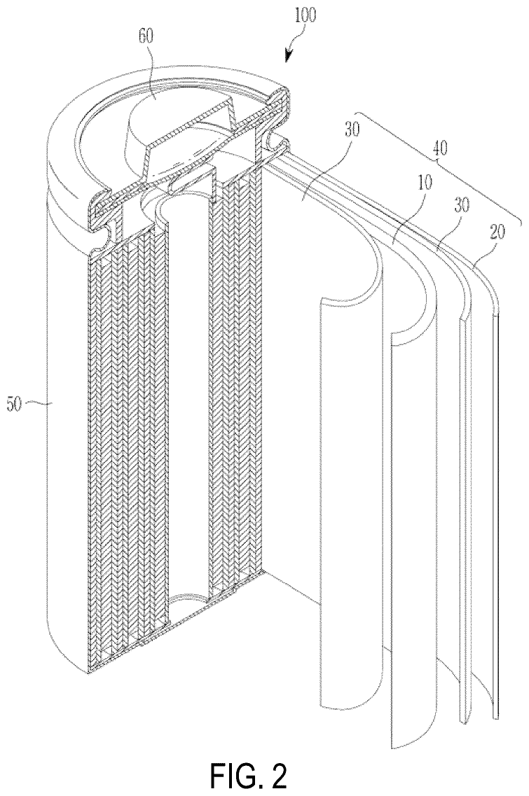

FIG. 2 is a cutaway perspective view schematically showing a rechargeable lithium battery according to one or more embodiments.

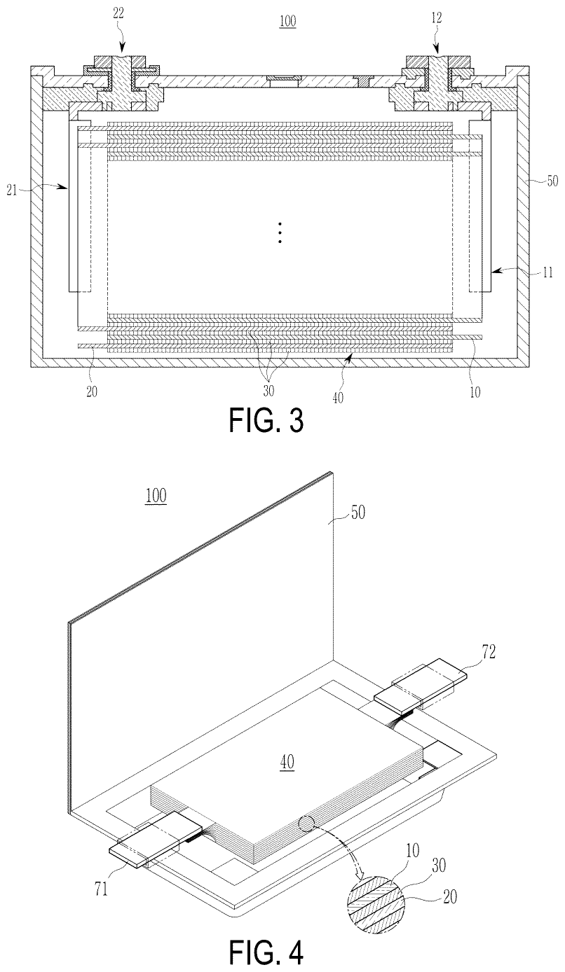

FIG. 3 is a cross-sectional view schematically showing a rechargeable lithium battery according to one or more embodiments.

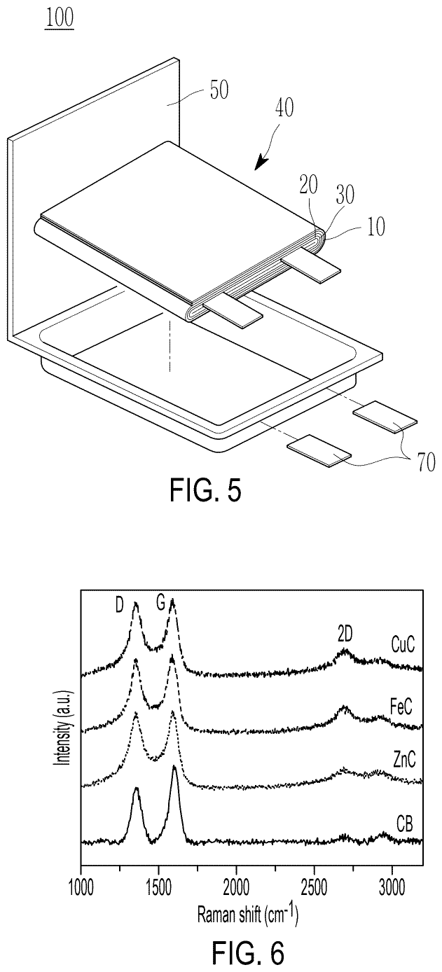

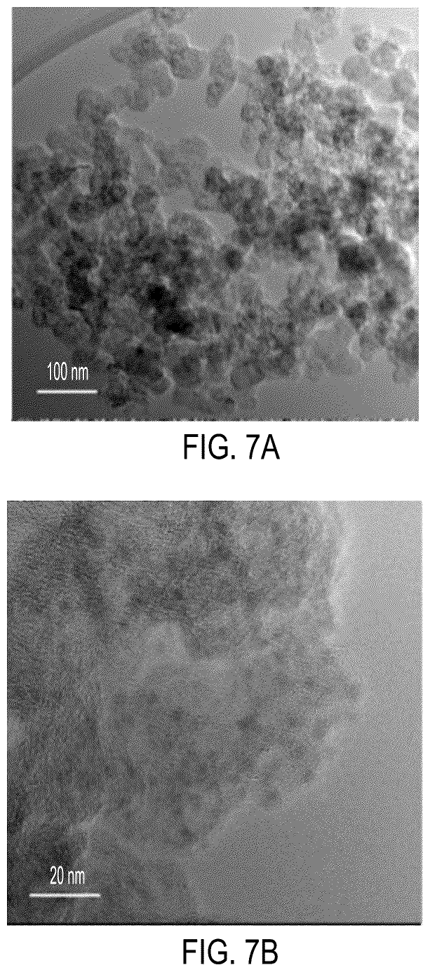

FIG. 4 and FIG. 5 are perspective views schematically showing rechargeable lithium batteries according to one or more embodiments.

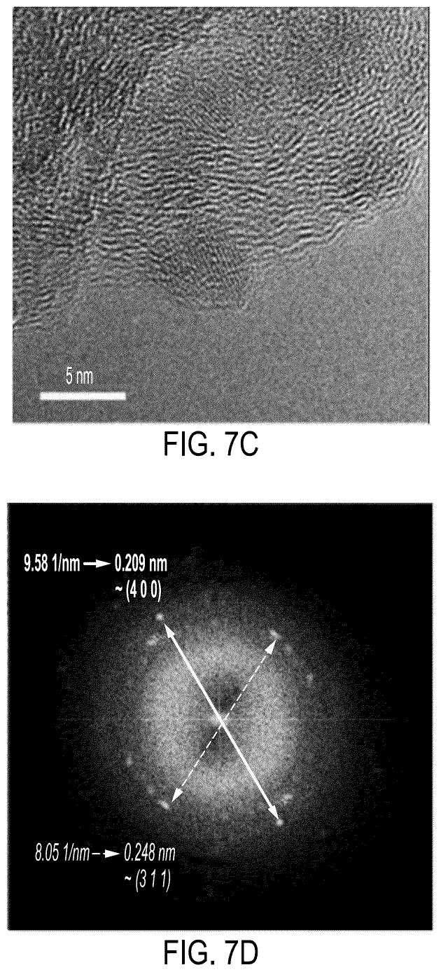

FIG. 6 is a chart showing the Raman spectra of nanocomposites according to one or more embodiments.

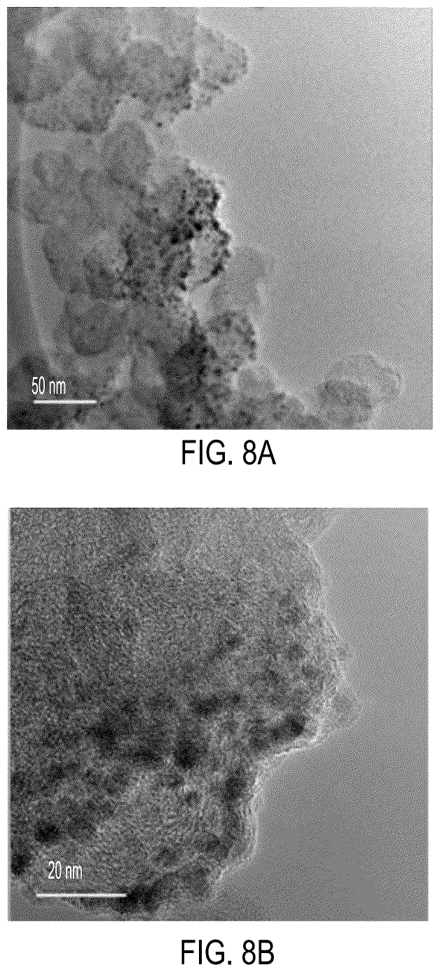

FIGS. 7A-7D are high-resolution transmission electron microscopy (HR-TEM) images of an iron-carbon nanocomposite according to one or more embodiments.

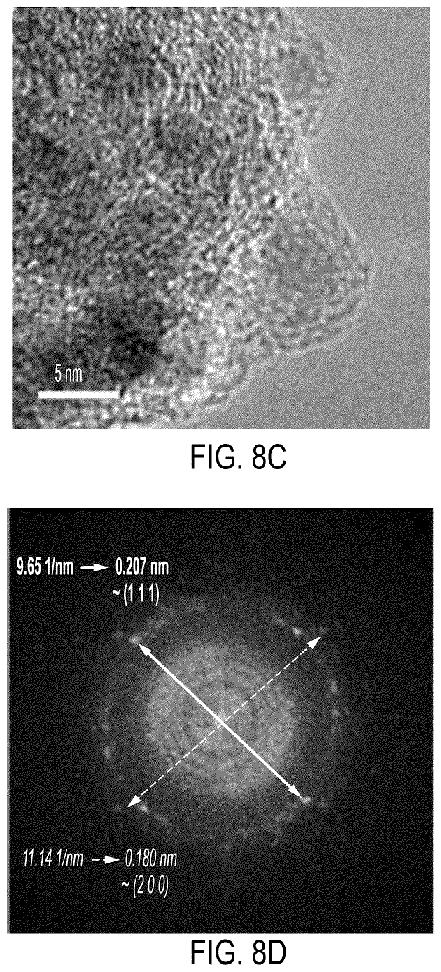

FIGS. 8A-8D are HR-TEM images of a copper-carbon nanocomposite according to one or more embodiments.

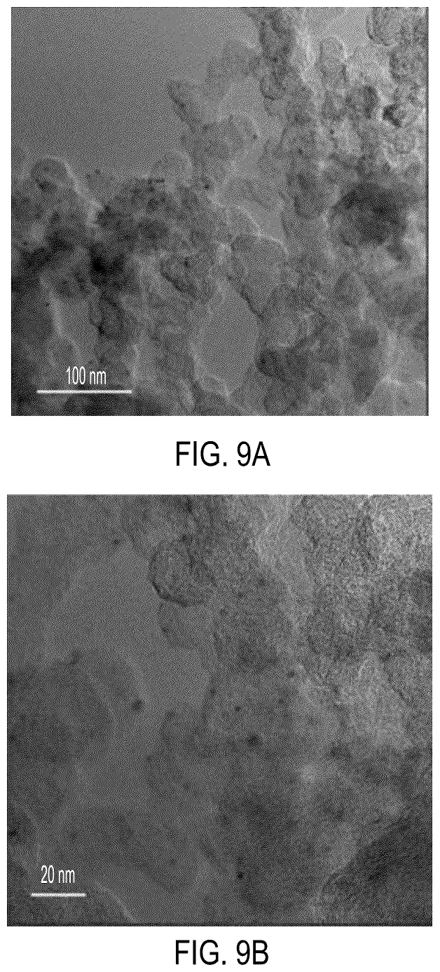

FIGS. 9A-9D are HR-TEM images of a zinc-carbon nanocomposite according to one or more embodiments.

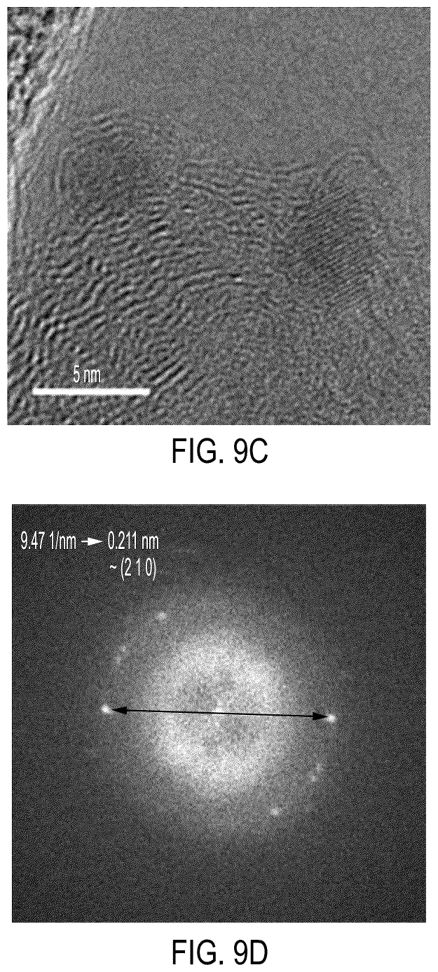

FIG. 10A is chart of the X-ray photoelectron spectroscopy (XPS) analysis of the nanocomposite of FIGS. 7A-7D.

FIG. 10B is a chart of the XPS analysis of the nanocomposite of FIGS. 8A-8D.

FIG. 10C is a chart of the XPS analysis of the nanocomposite of FIGS. 9A-9D.

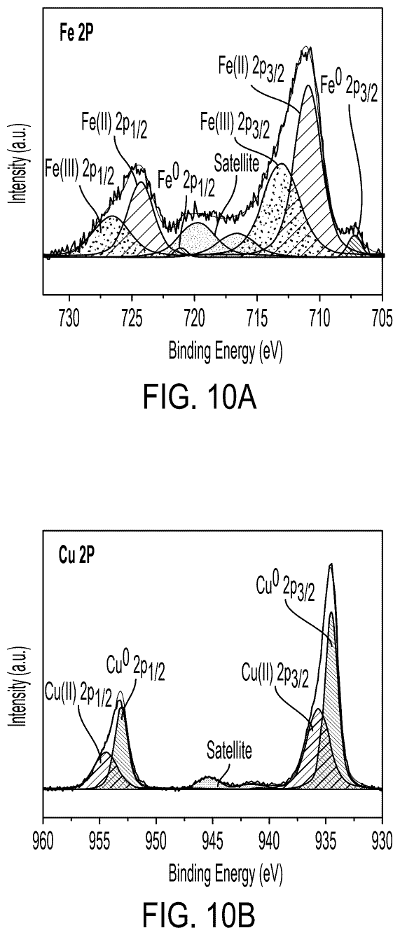

FIG. 11 is a scanning transmission electron microscopy (STEM) image and EDS elemental maps of metal alloy nanoparticles according to one or more embodiments.

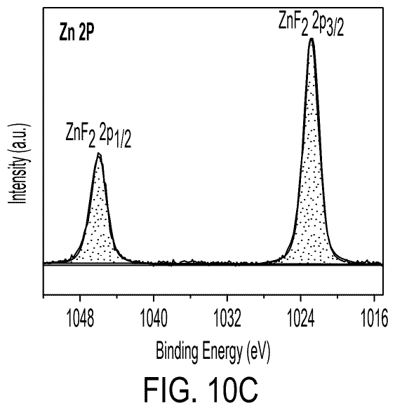

FIG. 12 is a chart of galvanostatic cycling performance of nanocomposites according to one or more embodiments showing nucleation overpotential during the first cycle.

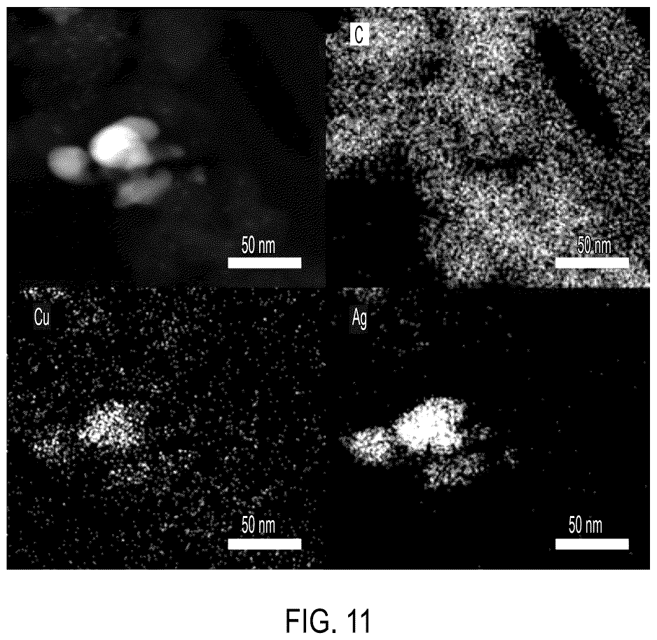

FIG. 13 is a chart of galvanostatic cycling performance of nanocomposites according to one or more embodiments showing nucleation overpotential during the 20^{th} cycle.

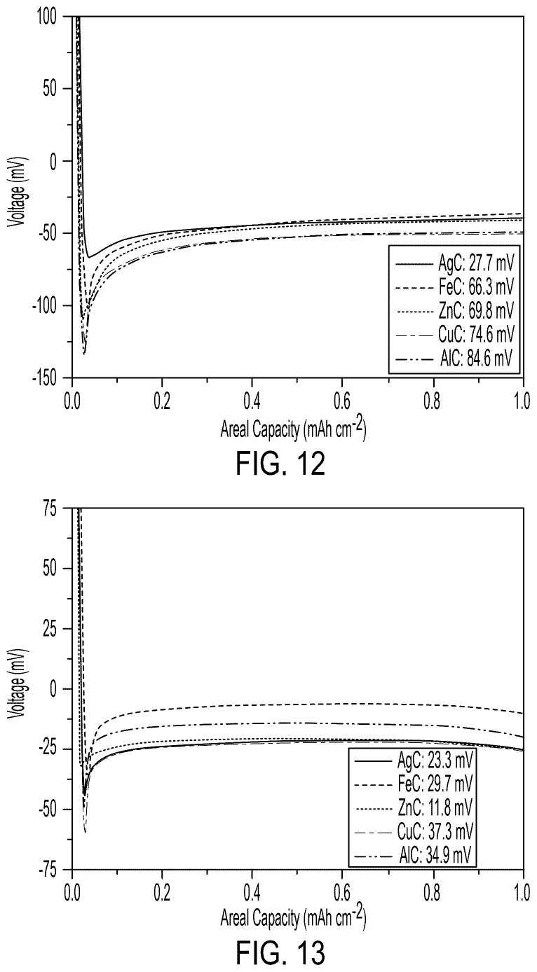

FIG. 14 is a chart of coulombic efficiency of nanocomposites according to one or more embodiments.

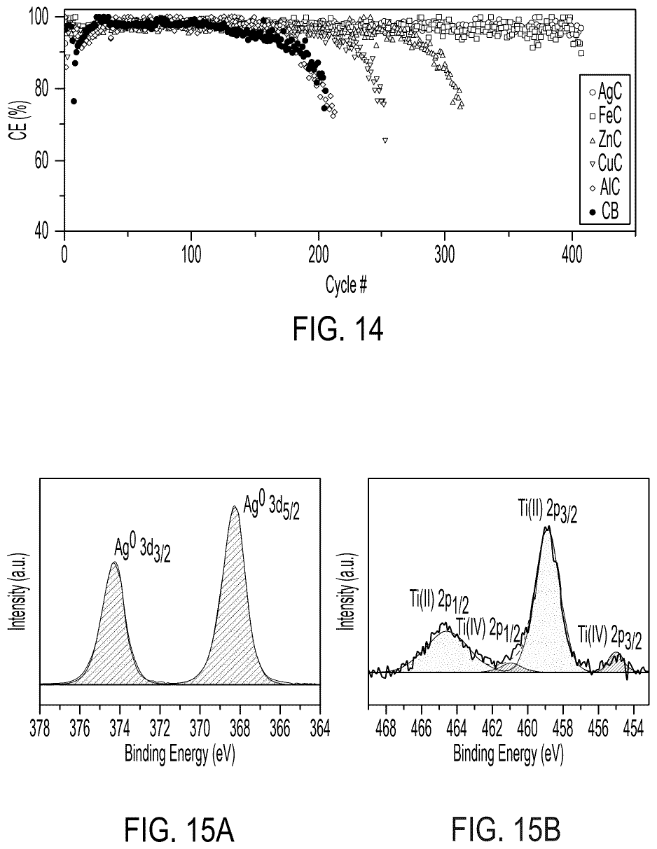

FIGS. 15A-15B are charts of XPS analysis of a silver titanium-carbon nanocomposite according to one or more embodiments.

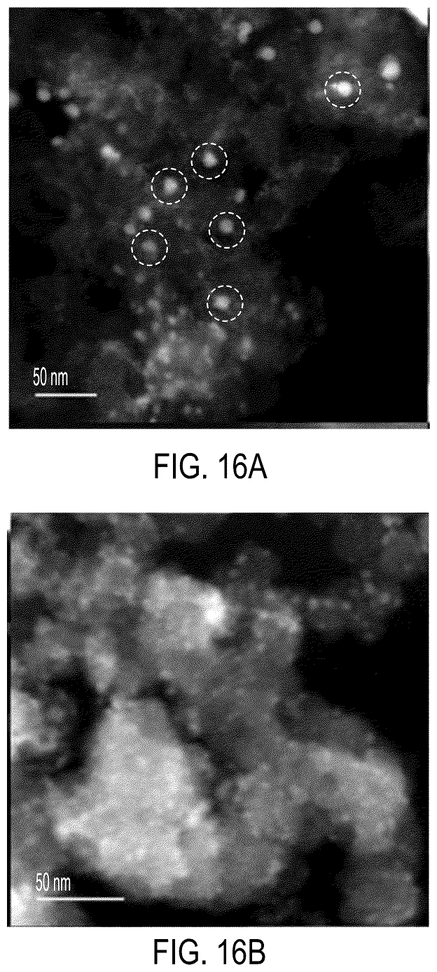

FIGS. 16A-16D are HR-TEM images of the nanocomposite of FIG. 15.

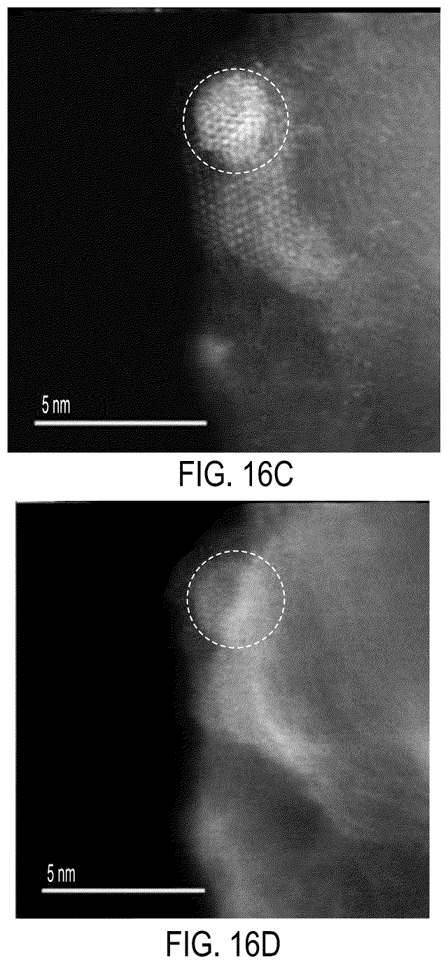

FIG. 17 is a chart of electrochemical performance of silver titanium-carbon nanocomposites according to one or more embodiments during the first cycle.

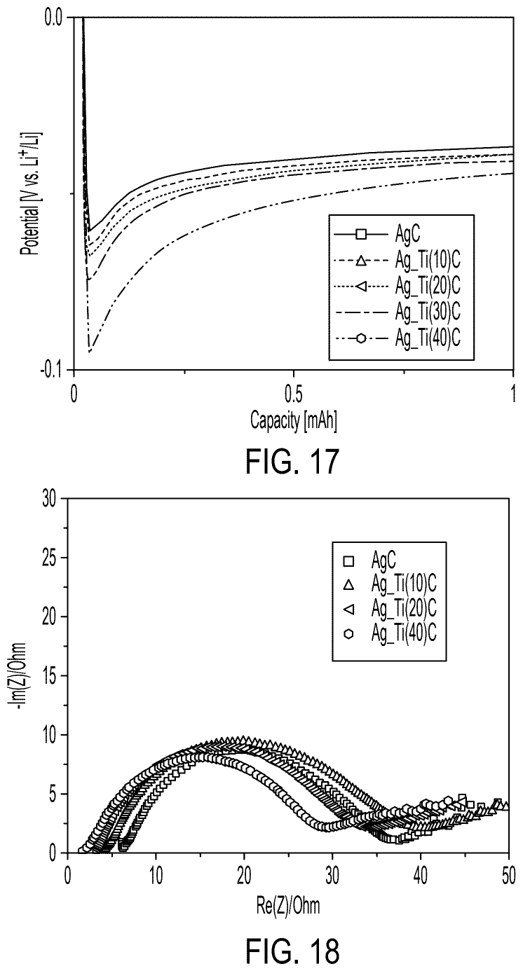

FIG. 18 is a chart of Nyquist plots showing the impedance spectra of silver titanium-carbon nanocomposites according to one or more embodiments.

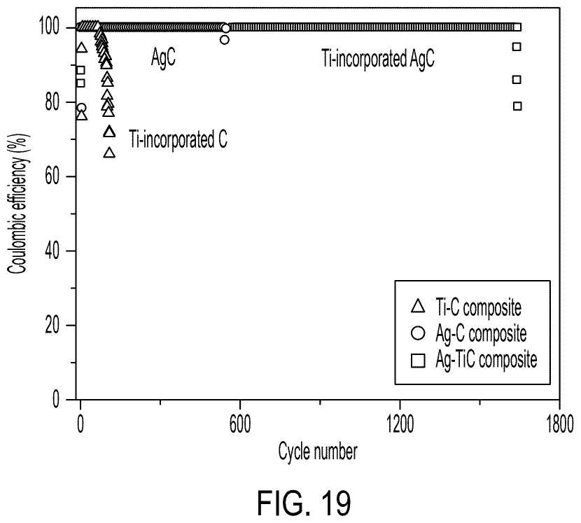

FIG. 19 is chart of electrochemical performance of half cells using the nanocomposites according to one or more embodiments.

### DETAILED DESCRIPTION

Reference will now be made, in more detail, to embodiments of the present disclosure, examples of which are illustrated in the accompanying drawings. Aspects and features of embodiments of the present disclosure, and implementation methods thereof, will be described with reference to the accompanying drawings. The subject matter of the present disclosure, however, may be embodied in various suitable forms and should not be construed as being limited to the embodiments illustrated herein. Rather, these embodiments are provided as examples so that the present disclosure will be thorough and complete and will fully convey the present disclosure to those skilled in the art.

It will be understood that when an element or layer is referred to as being “on,” “connected to,” or “coupled to” another element or layer, it may be directly on, connected, or coupled to the other element or layer or one or more intervening elements or layers may also be present. When an element or layer is referred to as being “directly on,” “directly connected to,” or “directly coupled to” another element or layer, there are no intervening elements or layers present. For example, when a first element is described as being “coupled” or “connected” to a second element, the first element may be directly coupled or connected to the second element or the first element may be indirectly coupled or connected to the second element via one or more intervening elements.

In the figures, dimensions of the various elements, layers, etc. may be exaggerated for clarity of illustration. The same reference numerals designate the same elements. As used herein, the term “and/or” includes any and all combinations of one or more of the associated listed items. Further, the use of “may” when describing embodiments of the present disclosure relates to “one or more embodiments of the present disclosure.” Expressions, such as “at least one of” and “any one of,” when preceding a list of elements, modify the entire list of elements and do not modify the individual elements of the list. For example, the expression “at least one of a, b, or c” indicates only a, only b, only c, both a and b, both a and c, both b and c, all of a, b, and c, or variations thereof. As used herein, the terms “use,” “using,” and “used” may be considered synonymous with the terms “utilize,” “utilizing,” and “utilized,” respectively. As used herein, the terms “substantially,” “about,” and similar terms are used as terms of approximation and not as terms of degree, and are intended to account for the inherent variations in measured or calculated values that would be recognized by those of ordinary skill in the art.

It will be understood that, although the terms first, second, third, etc. may be used herein to describe various elements, components, regions, layers, and/or sections, these elements, components, regions, layers, and/or sections should not be limited by these terms. These terms are used to distinguish one element, component, region, layer, or section from another element, component, region, layer, or section. Thus, a first element, component, region, layer, or section discussed below could be termed a second element, component, region, layer, or section without departing from the teachings of example embodiments.

Spatially relative terms, such as “beneath,” “below,” “lower,” “above,” “upper,” and the like, may be used herein for ease of description to describe one element or feature's relationship to another element(s) or feature(s) as illustrated in the figures. It will be understood that the spatially relative terms are intended to encompass different orientations of the device in use or operation in addition to the orientation depicted in the figures. For example, if the device in the figures is turned over, elements described as “below” or “beneath” other elements or features would then be oriented “above” or “over” the other elements or features. Thus, the term “below” may encompass both an orientation of above and below. The device may be otherwise oriented (rotated 90 degrees or at other orientations), and the spatially relative descriptors used herein should be interpreted accordingly.

The terminology used herein is for the purpose of describing embodiments of the present disclosure and is not intended to be limiting of the present disclosure. As used herein, the singular forms “a” and “an” are intended to include the plural forms as well, unless the context clearly indicates otherwise. It will be further understood that the terms “comprises,” comprising,” “comprise,” “including,” “includes,” “include,” “having,” “has,” and “have,”,” when used in this specification, specify the presence of stated features, integers, steps, operations, elements, and/or components but do not preclude the presence or addition of one or more other features, integers, steps, operations, elements, components, and/or groups thereof.

A person of ordinary skill in the art would appreciate, in view of the present disclosure in its entirety, that each suitable feature of the various embodiments of the present disclosure may be combined or combined with each other, partially or entirely, and may be technically interlocked and operated in various suitable ways, and each embodiment may be implemented independently of each other or in conjunction with each other in any suitable manner unless otherwise stated or implied.

Unless otherwise defined, all terms (including chemical, technical and scientific terms) utilized herein have the same meaning as commonly understood by one of ordinary skill in the art to which this disclosure pertains. It will be further understood that terms, such as those defined in commonly utilized dictionaries, should be interpreted as having a meaning that is consistent with their meaning in the context of the related art and the present disclosure, and will not be interpreted in an idealized or overly formal sense.

The term “may” will be understood to refer to “one or more embodiments of the present disclosure,” some of which include the described element and some of which exclude that element and/or include an alternate element. Similarly, alternative language such as “or” refers to “one or more embodiments of the present disclosure,” each including a corresponding listed item. Descriptions of features or aspects within each embodiment should typically be considered as available for other similar features or aspects in other embodiments.

In this context, “consisting essentially of” indicates that any additional components will not materially affect the chemical, physical, optical and/or electrical properties of the semiconductor film.

Further, in this specification, the phrase “plan view,” indicates viewing a target portion from the top, and the phrase “on a cross-section” indicates viewing a cross-section formed by vertically cutting a target portion from the side.

In the context of the present application and unless otherwise defined, the terms “use,” “using,” and “used” may be considered synonymous with the terms “utilize,” “utilizing,” and “utilized,” respectively.

The term “particle diameter” as utilized herein refers to an average diameter of particles if the particles are spherical, and refers to an average major axis length of particles if the particles are non-spherical. For example, the average particle diameter may be measured by any suitable method in the art, for example, by a particle size analyzer, and/or by a transmission electron microscopic image and/or a scanning electron microscopic image. A value for the average particle diameter may be obtained by dynamic light scattering analysis methodology, performing data analysis, counting the number of particles for each particle size range, and calculating the data obtained. Unless otherwise defined, the average particle diameter may refer to the diameter (D₅₀) of particles having a cumulative volume of 50 volume % in the particle size distribution. If measuring by laser diffraction, for example, the particles to be measured are dispersed in a dispersion medium and then introduced into a related art laser diffraction particle size measuring device (e.g., MT 3000 available from Microtrac, Ltd.) utilizing ultrasonic waves at about 28 kHz, and after irradiation with an output of 60 W, the average particle diameter (D₅₀) based on 50% of the particle size distribution in the measuring device may be calculated. As utilized herein, if (e.g., when) a definition is not otherwise provided, the average particle diameter refers to a diameter (D₅₀) of particles having a cumulative volume of 50 volume % in the particle size distribution that is obtained by measuring the size (diameter or major axis length) of about 200 particles at random in a transmission electron microscopic image.

The preceding and other objects and features of embodiments of the present disclosure will become more apparent to those of ordinary skill in the art by describing example embodiments thereof in more detail with reference to the accompanying drawings. In the drawings, the thickness of layers, films, panels, regions, and/or the like, may be exaggerated for clarity and like reference numerals designate like elements throughout, and duplicative descriptions thereof may not be provided in the specification. Unless stated otherwise in the specification, if a portion of a layer, film, region, plate and/or the like is referred to as being “on” another portion, this includes not only the case in which the portion is “directly on” another portion but also the case in which there is another portion interposed therebetween.

Also, any numerical range disclosed and/or recited herein is intended to include all sub-ranges of the same numerical precision subsumed within the recited range. For example, a range of “1.0 to 10.0” is intended to include all subranges between (and including) the recited minimum value of 1.0 and the recited maximum value of 10.0, that is, having a minimum value equal to or greater than 1.0 and a maximum value equal to or less than 10.0, such as, for example, 2.4 to 7.6. Any maximum numerical limitation recited herein is intended to include all lower numerical limitations subsumed therein, and any minimum numerical limitation recited in this specification is intended to include all higher numerical limitations subsumed therein. Accordingly, Applicant reserves the right to amend this specification, including the claims, to expressly recite any sub-range subsumed within the ranges expressly recited herein. All such ranges are intended to be inherently described in this specification such that amending to expressly recite any such subranges would comply with the requirements of 35 U.S.C. § 112(a) and 35 U.S.C. § 132(a).

### Introduction

One or more embodiments of the present disclosure relate to fast and scalable one-step UV-laser based manufacturing methods that provide one or more suitable silver-free metal nanoparticles in a carbon nanocomposite for use as a lithium metal anode (LMA) host in LMBs and ASSBs. As used herein, the term “silver-free metal nanoparticles” means that the metal nanoparticles are completely free of silver or substantially free of silver such that silver is present in the metal nanoparticles, if at all, only as an incidental impurity. FIG. 1 shows the UV-laser-based manufacturing method that includes casting a slurry of metal precursor(s), a carbonaceous material and a binder onto a current collector, followed by UV-laser irradiation to synthesize the nanocomposite (LMA host) on the current collector directly.

Because one or more suitable metal precursors (e.g., Al, Cu, Fe, Zn) may be formed into the carbonaceous composites the methods of the present disclosure address a number of current challenges associated with the practical application of LMAs in LMBs. For example, composites having metal alloy nanoparticles may provide materials having greater lithiophobicity than carbon that can reduce the mobility of lithiophilic nanoparticles to provide more effective plating of Li on the current collector.

The one-step UV-laser irradiation method of embodiments of the present disclosure may be used to incorporate lithiophobic materials (e.g., Ti) into a carbonaceous matrix to ensure that Li concentrates on the metal nanoparticles to enhance and/or increase Li-ion mobility thereby enhancing and/or improving Li-ion transport in the composite. The integration of Ti-incorporated carbon in the composite concentrates Li plating on lithiophilic metal nanoparticles and enhances Li transport properties.

The methods of embodiments of the present disclosure provide Ag—C composites configured to limit the mobility of Ag metal nanoparticles e.g., during cyclic lithium plating and stripping.

The methods of embodiments of the present disclosure provide for the preparation of materials having selectable compositions and structural controls and may potentially revolutionize the manufacturing landscape by reducing costs, energy requirements, and production time while enhancing the performance and safety of LMBs. For example, the methods of embodiments of the present disclosure promote more uniform Li deposition to improve battery performance and use economical materials, accompanied by minimal or reduced decreases in both volumetric and gravimetric energy densities.

### Interlayer

An interlayer according to one or more embodiments of the present disclosure is for use in lithium metal battery (LMB), e.g., the LMB may be an anodeless all-solid-state lithium metal battery (ASSLMB) and/or the like, but the present disclosure is not limited thereto. For example, the interlayer may be utilized in a suitable anodeless all-solid-state battery (ASSB). The interlayer may be an anode host.

In one or more embodiments, the interlayer includes a nanocomposite, a matrix, and a binder. The nanocomposite includes nanoparticles that may include metals, metalloids, alloys thereof, compounds thereof, and suitable combinations thereof. In one or more embodiments, the nanocomposite may be a silver-free nanocomposite. For example, the nanocomposite may be completely or substantially free of silver (Ag). As used herein, “substantially free of silver” means that silver is present, if at all, only as an incidental impurity. In one or more embodiments, the nanocomposite does not include or excludes silver. In one or more embodiments, the interlayer may be or include a film including the nanocomposite, the matrix, and the binder.

The nanocomposite may be a metal nanoparticle carbon (M-C) nanocomposite including nanoparticles selected from among at least one metal and at least one metal alloy. The nanoparticles of the M-C nanocomposite may include aluminum, antimony, bismuth, cobalt, copper, germanium, gold, iron, molybdenum, nickel, platinum, silicon, tellurium, tin, titanium, tungsten, and/or zinc. The nanoparticles of the M-C nanocomposite may include an alloy of aluminum, antimony, bismuth, cobalt, copper, germanium, gold, iron, molybdenum, nickel, platinum, silicon, tellurium, tin, titanium, tungsten, and/or zinc.

In one or more embodiments, the nanoparticles may be metal nanoparticles (M-NPs) including aluminum, copper, iron, and/or zinc, and/or an alloy thereof. For example, the M-NPs may include aluminum, copper, iron, zinc, an aluminum/copper alloy, an aluminum/iron alloy, an aluminum/zinc alloy, a copper/iron alloy, a copper/zinc alloy, and/or a zinc/iron alloy, and combinations thereof.

The nanocomposite includes a carbonaceous material including at least one of amorphous carbon, graphite, graphene, reduced graphene oxide, carbon nanotube, or combinations thereof. In one or more embodiments, the carbonaceous material includes amorphous graphite, flake graphite, crystalline graphite, or combinations thereof.

The term “matrix” as used herein may be a bulk carbonaceous material that is separate and distinct from the nanocomposite and components thereof, (e.g., the nanoparticles). The bulk carbonaceous material may include at least one of amorphous carbon, crystalline carbon, graphite, graphene, reduced graphene oxide, carbon nanotube, or combinations thereof. In one or more embodiments, the bulk carbonaceous material includes amorphous graphite, flake graphite, crystalline graphite, or combinations thereof. In one or more embodiments, the bulk carbonaceous material may be substantially the same as the carbonaceous material included in the nanocomposite.

In one or more embodiments, the nanocomposite may be a metal nanoparticle titanium-carbon (M-TiC) nanocomposite that includes titanium (Ti) and the nanoparticles. The M-TiC nanocomposite includes a titanium-carbon (TiC) compound having Ti—C chemical bonds selected from among ionic bonds, covalent bonds, and combinations thereof. The TiC compound may be included in the M-TiC nanocomposite and/or in the matrix. In one or more embodiments, the nanoparticles may include a coating around (e.g., surrounding) at least a portion of a surface of the nanoparticles and the coating may include the TiC compound. The TiC compound may have lithiophobic properties and the terms “lithiophobic” and “lithiophobicity” as used herein refer to a repulsion or non-attraction to atoms, ions and/or molecules containing lithium.

In one or more embodiments, Ti and/or the Ti—C compound may increase the lithiophobicity of the matrix and may enhance or increase adhesion and/or attraction of lithium to the nanoparticles (e.g., M-NPs). For example, the nanoparticles (e.g., M-NPs) may have lithiophilic properties and Ti and/or the Ti—C compound may concentrate lithium around the lithiophilic nanoparticles (e.g., M-NPs). The terms “lithiophilic” and “lithiophilicity” as used herein refer to adhesion or attraction to atoms, ions and/or molecules containing lithium.

In one or more embodiments, the nanoparticles (e.g., M-NPs) may exist dispersed, embedded and/or encapsulated in the matrix and in such embodiments, the matrix may include at least one of amorphous carbon, crystalline carbon, or graphite.

In one or more embodiments, an average particle diameter (D50) of the nanoparticles may be at least about 5 nanometer (nm), but the present disclosure is not limited thereto. For example, the average particle diameter (D50) of the nanoparticles may be about 5 nm to about 500 nm, about 6 nm to about 300 nm, about 7 nm to about 150 nm, about 8 nm to about 100 nm, about 8 nm to about 80 nm, about 8 nm to about 60 nm, about 8 nm to about 30 nm, or about 9 nm to about 11 nm.

The nanocomposite may be primary particles of the nanoparticles (e.g., M-NPs) and the carbonaceous material. An average particle diameter (D₅₀) of the primary particles may be, for example, about 0.5 μm to about 20 μm. For example, the primary particles of the nanocomposite may have the carbonaceous material coated on the surface of the nanoparticles (e.g., M-NPs). According to one or more embodiments, the nanocomposite may include a secondary particle (core) in which the primary particles are assembled and an amorphous carbon coating layer (shell) on the surface of the secondary particle. The amorphous carbon may also be present between the primary particles, for example, the primary particles may be coated with amorphous carbon.

In one or more embodiments, the primary particles and/or secondary particles of the nanocomposite may exist dispersed in the matrix and in such embodiments, the matrix may include at least one of amorphous carbon, crystalline carbon, or graphite.

The binder may be a liquid and/or solid and may be water-miscible, water-soluble, soluble in non-aqueous organic solvents, or a combination thereof, but the present disclosure is not limited thereto. The binder includes moieties (e.g., chemical functional groups) that may be polar and/or non-polar, may be selected from among hydrogen bond donor groups, hydrogen bond acceptor groups, acidic groups, basic groups, and/or combinations thereof. The hydrogen bond donor groups may be amines, halides, hydroxyl groups, sulfides, and/or the like, but the present disclosure is not limited thereto.

In one or more embodiments, the interlayer and/or the nanocomposite includes about 1 wt % to about 99.5 wt %, about 5 wt % to about 95 wt %, about 5 wt % to about 80 wt %, about 5 wt % to about 60 wt %, about 10 wt % to about 50 wt %, or about 40 wt % to about 90 wt % of the carbonaceous material, based on a total weight of the interlayer and/or the nanocomposite.

In one or more embodiments, the interlayer and/or the nanocomposite includes about 0.01 wt % to about 99 wt %, about 0.1 wt % to about 50 wt %, about 0.1 wt % to about 20 wt %, or about 1 wt % to about 10 wt % of the nanoparticles based on a total weight of the interlayer and/or the nanocomposite. In one or more embodiments, a weight ratio of an amount of the nanoparticles to an amount of the carbonaceous material may be about 1 to about 100, e.g., about 1 to about 60, about 1 to about 50, about 1 to about 20, about 1 to about 10, or about 1 to about 5.

In one or more embodiments, the interlayer and/or the nanocomposite includes about 0.01 wt % to about 99 wt %, about 0.01 wt % to about 50 wt %, about 0.1 wt % to about 25 wt %, about 1 wt % to about 15 wt %, about 3 wt % to about 10 wt %, or about 4 wt % to about 8 wt % of the binder based on a total weight of the interlayer and/or the nanocomposite. In one or more embodiments, a weight ratio of an amount of the binder to an amount of the nanoparticles may be about 1 to about 100, e.g., about 1 to about 60, about 1 to about 50, about 1 to about 20, about 1 to about 10, or about 1 to about 5.

In one or more embodiments, the interlayer and/or the M-TiC nanocomposite includes about 0.01 wt % to about 99 wt %, about 0.01 wt % to about 50 wt %, about 0.1 wt % to about 25 wt %, about 1 wt % to about 15 wt %, about 3 wt % to about 10 wt %, about 4 wt % to about 8 wt %, about 0.001 wt % to about 0.5 wt %, about 0.001 wt % to about 0.1 wt %, or about 0.005 wt % to about 0.05 wt % of the titanium based on a total weight of the interlayer and/or the M-TiC nanocomposite.

In one or more embodiments, a thickness of the nanocomposite interlayer may be about 1 micrometer (μm) to about 30 μm. For example, the thickness of the nanocomposite interlayer may be about 1 μm to about 25 μm, about 2 μm to about 20 μm, about 3 μm to about 15 μm, or about 4 μm to about 12 μm.

An interlayer according to one or more embodiments of the present disclosure includes a silver titanium-carbon (Ag—TiC) nanocomposite, a matrix, and a binder. The Ag—TiC nanocomposite includes silver nanoparticles and also includes the titanium-carbon (TiC) compound and the carbonaceous material as described herein. The Ag—TiC nanocomposite may be utilized in an interlayer for a lithium metal battery (LMB), e.g., the LMB may be an anodeless all-solid-state lithium metal battery (ASSLMB) and/or the like, but the present disclosure is not limited thereto. For example, the Ag—TiC nanocomposite may be utilized in an interlayer for a suitable anodeless all-solid-state battery (ASSB).

### Lithium Metal Battery

A lithium metal battery (LMB) according to one or more embodiments of the present disclosure may be an anodeless all-solid-state battery (ASSB), such as an anodeless all-solid-state lithium metal battery (ASSLMB). The term “anodeless” as used herein is a battery that excludes a permanent anode (e.g., negative electrode) and may include a plated anode (e.g., negative electrode) that is a transient structure, as described in more detail elsewhere herein. The LMB and/or ASSLMB of embodiments of the present disclosure may be rechargeable and may be applied in vehicles, electric vehicles, mobile phones, electronic devices, and/or the like but the present disclosure is not limited thereto.

The LMB may be classified into cylindrical, prismatic, pouch, coin, and/or the like, depending on its shape. FIGS. 2-5 are schematic diagrams showing the LMB according to one or more embodiments, where FIG. 2 is a cylindrical battery, FIG. 3 is a prismatic battery, and FIGS. 4-5 are each a pouch-shaped battery. Referring to FIGS. 2-5, the anodeless battery 100 includes an electrode assembly 40 with a separator 30 between the positive electrode (cathode) 10 and the negative electrode (anode) 20, and a case 50 in which the electrode assembly 40 is housed. The positive electrode (cathode) 10, the negative electrode (anode) 20, and the separator 30 may be impregnated with an electrolyte. As shown in FIG. 2, the LMB 100 may include a sealing member 60 that seals the case 50. In FIG. 3, the LMB 100 may include a positive electrode (cathode) lead tab 11, a positive terminal 12, a negative electrode (anode) lead tab 21, and a negative terminal 22. As shown in FIGS. 4-5, the LMB 100 includes electrode tabs 70, that may be a positive electrode (cathode) tab 71 and a negative electrode (anode) tab 72, that serve as an electrical path to induce the current formed in the electrode assembly 40 to the outside.

The LMB of embodiments of the present disclosure includes a positive electrode having a positive electrode active material (e.g., cathode active material (CAM)). In one or more embodiments, CAM may be a nickel composite oxide (e.g., layered nickel composite oxide) including nickel, oxygen, and about one to about five elements selected from among aluminum (AI), boron (B), cobalt (Co), iron (Fe), magnesium (Mg), manganese (Mn), titanium (Ti), tungsten (W), and/or a (e.g., any suitable) combination thereof. In one or more embodiments, the CAM may be a lithium nickel composite oxide, a lithium nickel-cobalt-aluminum composite oxide (NCA-based composite oxide), and/or a lithium nickel-manganese-cobalt-based composite oxide (NMC-based composite oxide). The term “based composite oxide,” as used herein, is a CAM oxide material that includes elements (e.g., metal elements) in addition to the elements in the name of the CAM. In one or more embodiments, the CAM may be lithium nickel oxide (LiNiO₂), lithium nickel cobalt aluminum oxide (NCA) (LiNiCoAlO₂), lithium nickel manganese cobalt oxide (NMC) (LiNiCoMnO₂), or a (e.g., any suitable) combination thereof. For example, the nickel composite oxide may be at least one selected from among LiNi_{0.94}Co_{0.02}A_{0.04}O₂ (NCA94), LiNi_{0.85}Co_{0.10}Mn_{0.05}O₂ (NCM 851005), LiNi_{0.8}C_{0.1}Mn_{0.1}O₂ (NCM 811), and LiNi_{0.6}Co_{0.2}Mn_{0.2}O₂ (NCM 622).

The nickel composite oxide may include a mole fraction of at least about 0.80 nickel, based on a total molar composition of the nickel composite oxide. In one or more embodiments, the mole fraction of nickel may be about 0.05 to about 0.999, about 0.80 to about 0.999, about 0.85 to about 0.99, or about 0.90 to about 0.95, based on a total molar composition of the nickel composite oxide.

The LMB includes the interlayer of embodiments of the present disclosure and a negative electrode current collector and the interlayer may be on the negative electrode current collector. The negative electrode current collector may be or include a metal foil. In one or more embodiments, the negative electrode current collector may include stainless steel, iron, nickel, manganese, copper, titanium, aluminum, or combinations thereof. In one or more embodiments, the negative electrode current collector includes an amount of unspecified trace elements of less than about 1%, e.g. about 10 ppm to about 5000 ppm.

### Electrolyte

The LMB of embodiments of the present disclosure includes an electrolyte between the positive electrode and the interlayer and the interlayer may be between the electrolyte and the negative electrode current collector. In one or more embodiments, the electrolyte may be or include a solid-state electrolyte (e.g., all-solid electrolyte) that includes any material suitable for use as an ion conductive material. Non-limiting examples of the solid-state electrolyte may include an inorganic solid-state electrolyte, a crystalline solid-state electrolyte, an amorphous solid-state electrolyte, a polymeric solid-state electrolyte, or a combination thereof.

In one or more embodiments, the solid-state electrolyte may be a sulfide-based solid-state electrolyte, an oxide-based solid-state electrolyte, a lithium aluminum titanium phosphate (LATP) solid-state electrolyte, an anti-perovskite solid-state electrolyte, or a combination thereof. The sulfide-based solid-state electrolyte may include, for example, Li, S, and P and may optionally further include a halogen element. The sulfide-based solid-state electrolyte may be selected from sulfide-based solid-state electrolytes utilized in an electrolyte layer. For example, the sulfide-based solid-state electrolyte may have an ionic conductivity of at least about 1×10⁻⁵ Siemens per centimeter (S/cm) at room temperature. The oxide-based solid-state electrolyte may include, for example, Li, O, and a transition metal element and may optionally further include other elements. For example, the oxide-based solid-state electrolyte may be a solid-state electrolyte having an ionic conductivity of at least about 1×10⁻⁵ S/cm at room temperature. The oxide-based solid-state electrolyte may be selected from oxide-based solid-state electrolytes suitable for use in an electrolyte layer.

In one or more embodiments, the solid-state electrolyte may include at least one selected from among LiₚPSₙX, Li₂S—P₂S₅, Li₂S—P₂S₅—LiX, Li₂S—P₂S₅—Li₂O, Li₂S—P₂S₅—Li₂O—LiI, Li₂S—SiS₂, Li₂S—SiS₂—LiI, Li₂S—SiS₂—LiBr, Li₂S—SiS₂—LiCl, Li₂S—SiS₂—B₂S₃—LiI, Li₂S—SiS₂—P₂S₅—LiI, Li₂S—B₂S₃, Li₂S—P₂S₅—ZₘSₙ, Li₂S—GeS₂, Li₂S—SiS₂—Li₃PO₄, Li₂S—SiS₂-LiₚMO_{q}, and a combination thereof. For example, X may be a halogen, Z may be Ge, Zn, or Ga, M may be P, Si, Ge, B, Al, Ga, or In, and m, n, p, and q may each independently be a positive integer. The solid-state electrolyte may include at least one compound of formula LiₚPSₙX, having p of 1 to 6, n of 1 to 5, and X may be F, Cl, Br or I. For example, the solid-state electrolyte may include Li₆PS₅F, Li₆PS₅Cl, Li₆PS₅Br, and/or Li₆PS₅I.

### Method of Manufacturing an Interlayer

Methods of manufacturing an interlayer according to one or more embodiments of the present disclosure include providing a redox active compound, and the carbonaceous material and binder as described herein to form a slurry. The redox active compound may be at least one compound comprising a metal, a metalloid, or combinations thereof. The redox active compound may be an ionic compound (e.g., salt) and/or a molecular compound (e.g., covalent compound excluding ionic bonds) including the metal and/or metalloid. The metal of the redox active compound may be an alkali metal, an alkaline earth metal, a transition metal, or combinations thereof. In one or more embodiments, the metal of the redox active compound may be aluminum, antimony, bismuth, cobalt, copper, germanium, gold, iron, molybdenum, nickel, platinum, silicon, tellurium, tin, titanium, tungsten, and/or zinc. For example, the redox active compound may be at least one compound including an acetylacetonate (acac) anion, but the present disclosure is not limited thereto. In one or more embodiments, the redox active compound may be at least one of Al(acac)₃, Cu(acac)₂, Fe(acac)₃, Ti(acac)₂, or Zn(acac)₂.

The methods include mixing the slurry and distributing the redox active compound substantially uniformly within the carbonaceous material, e.g., by mixing with agitation suitable or sufficient to provide the slurry as a homogeneous and flowable slurry. For example, the slurry may be mixed in a centrifugal mixer or planetary mixer and at a mixing speed may at least about 1000 rpm.

The methods include applying (e.g., coating) the slurry to a current collector, e.g., a negative electrode current collector or a positive electrode current collector. The slurry may be applied with a doctor blade, but the present disclosure is not limited thereto. In one or more embodiments, the slurry may be applied using spin casting, tape casting, and/or roll-to-roll coating technology.

The methods of embodiments of the present disclosure include irradiating the slurry to provide (e.g., produce) an interlayer including a nanocomposite that includes metal nanoparticles (M-NPs) distributed substantially uniformly within the carbonaceous material. For example, the slurry may be irradiated by UV-laser technology. The method of embodiments of the present disclosure may include a one-step (e.g., single act) UV-laser technology irradiation process to provide an interlayer including the nanocomposite.

A speed of the UV-laser irradiation may be about 10 millimeter per second (mm/s) to about 1000 mm/s, about 50 mm/s to about 500 mm/s, or about 80 mm/s to about 120 mm/s.

A repetition rate of the UV-laser irradiation may be about 50 kilohertz (Hz) to about 500 kHz, about 70 kHz to about 300 kHz, or about 230 kHz to about 270 kHz.

A spot diameter of the UV-laser irradiation may be about 5 micrometer (μm) to about 85 μm, about 15 μm to about 60 μm, or about 30 μm to about 40 μm.

A laser energy of the UV-laser irradiation may be about 0.01 microjoule (μJ) to about 100 μJ, about 0.1 μJ to about 50 μJ, about 0.5 μJ to about 5 μJ, or about 0.8 μJ to about 1.2 μJ.

In one or more embodiments, the redox active compound may exclude (e.g., not include) a silver (Ag)-containing compound and the nanocomposite may be a metal nanoparticle carbon (M-C) nanocomposite, a silver (Ag)-free metal nanoparticle carbon (M-C) nanocomposite, a metal alloy nanoparticle carbon (M-C) nanocomposite, or a silver (Ag)-free metal alloy nanoparticle carbon (M-C) nanocomposite.

In one or more embodiments, the redox active compound may include a Ti-containing compound and the nanocomposite may be a metal nanoparticle titanium-carbon (M-TiC) nanocomposite, a silver (Ag)-free metal nanoparticle titanium-carbon (M-TiC) nanocomposite, a metal alloy nanoparticle titanium-carbon (M-TiC) nanocomposite, and/or a silver (Ag)-free metal alloy nanoparticle titanium-carbon (M-TiC) nanocomposite. As used herein, the terms “silver (Ag)-free metal nanoparticle titanium-carbon (M-TiC) nanocomposite” and “silver (Ag)-free metal alloy nanoparticle titanium-carbon (M-TiC) nanocomposite” mean that the metal nanoparticle titanium-carbon (M-TiC) nanocomposite and the metal alloy nanoparticle titanium-carbon (M-TiC) nanocomposite are completely free of silver or substantially free of silver such that silver is present in the metal nanoparticle titanium-carbon (M-TiC) nanocomposite and the metal alloy nanoparticle titanium-carbon (M-TiC) nanocomposite, if at all, only as an incidental impurity.

In one or more embodiments, the redox active compound may include compounds containing Ag and Ti and the nanocomposite may be a Ag nanoparticle titanium-carbon (M-TiC) nanocomposite and/or a Ag-metal alloy nanoparticle titanium-carbon (M-TiC) nanocomposite.

Not wishing to be limited by any particular mechanism or theory, the redox active compound (e.g., Fe(acac)₃) may be reduced during UV-laser irradiation to provide nanoparticles of a metal element (e.g., neat metal, (e.g., Fe)). In some embodiments, Ti(IV) may be reduced during UV-laser irradiation to provide Ti(II) that forms chemical bonds to carbon atoms. The UV-laser irradiation process may include a redox process to provide the nanoparticles by reduction of the redox active compound, e.g., reduction of Fe cation to metallic Fe (e.g., neat Fe).

The methods may provide nanocomposites that enhance and/or improve Li-ion transport and/or limit the movement of metal nanoparticles, e.g., Ag nanoparticles, within the within the interlayer and/or nanocomposite during cyclic lithium plating and stripping.

In one or more embodiments, the methods may include transforming the carbonaceous material into graphite (e.g., graphitic carbon).

In one or more embodiments, the slurry includes about 1 wt % to about 99.5 wt %, about 5 wt % to about 95 wt %, about 5 wt % to about 80 wt %, about 5 wt % to about 60 wt %, about 10 wt % to about 50 wt %, or about 40 wt % to about 90 wt % of the carbonaceous material based on a total weight of the slurry.

In one or more embodiments, the slurry includes about 0.01 wt % to about 99 wt %, about 0.1 wt % to about 50 wt %, about 0.1 wt % to about 20 wt %, or about 1 wt % to about 10 wt % of the redox active compound based on a total weight of the slurry.

In one or more embodiments, the slurry includes about 0.01 wt % to about 99 wt %, about 0.01 wt % to about 50 wt %, about 0.1 wt % to about 25 wt %, about 1 wt % to about 15 wt %, about 3 wt % to about 10 wt %, or about 4 wt % to about 8 wt % of the binder based on a total weight of the slurry.

In one or more embodiments, the slurry includes about 0.01 wt % to about 99 wt %, about 0.01 wt % to about 50 wt %, about 0.1 wt % to about 25 wt %, about 1 wt % to about 15 wt %, about 3 wt % to about 10 wt %, or about 4 wt % to about 8 wt %, about 0.001 wt % to about 0.5 wt %, about 0.001 wt % to about 0.1 wt %, or about 0.005 wt % to about 0.05 wt % of the titanium, based on a total weight of the slurry.

### Method of Operating an LMB

Methods of operating the LMB of embodiments of the present disclosure include an LMB having an interlayer comprising a silver-free nanocomposite as described herein on the anode (e.g., negative electrode) current collector. Before charging no anode is present and during the first charge a plated anode is generated (providing) between the interlayer and the anode (e.g., negative electrode) current collector of the LMB.

The methods may include operating an anodeless all-solid-state battery (ASSB) to provide a plated anode in the ASSB, and/or operating an all-solid-state lithium metal battery (ASSLMB) to provide a plated anode in the ASSLMB.

In one or more embodiments, the plated anode may include metal elements, metal alloys, metal compounds, or a combination thereof. For example, the plated anode may include lithium metal, lithium alloys, lithium compounds, or combinations thereof. The metal (e.g., lithium metal) that is plated on the anode (e.g., negative electrode) current collector may migrate from a component of the LMB. The metal (e.g., lithium metal) may migrate from the cathode active material of the positive electrode, from the solid-state electrolyte, or combinations thereof.

The methods may include discharging the LMB, ASSB or ASSLMB to remove the plated anode.

The methods of embodiments the present disclosure provide metal nanoparticles sized suitably or sufficiently small to increase specific surface area of the metal nanoparticles.

Hereinafter, referring to examples and comparative examples, the interlayer including a nanocomposite according to one or more embodiments and an LMB according to one or more embodiments of the disclosure are described in more detail. In some embodiments, the following examples are intended to assist understanding of the disclosure, and the scope of the disclosure is not limited thereto.

### Additional Features

The broader impact of embodiments of the present disclosure lies in its potential to revolutionize the LMB industry, particularly for EVs and portable electronics.

The enhanced performance and safety of LMBs can lead to longer-lasting, more efficient energy storage solutions, addressing key concerns in the EV market. By reducing the reliance on scarce and expensive materials like Ag and incorporating more abundant and cost-effective metals, embodiments of the present disclosure promote sustainability and cost-efficiency in battery production.

The scalable UV-laser based manufacturing process of embodiments of the present disclosure not only streamlines production but also allows for easy adjustment of material properties, making it adaptable for various suitable applications. This flexibility can drive innovation in other energy storage technologies, further expanding the impact of this research. Moreover, the improved understanding of electrochemical mechanisms and material interactions can contribute to advancements in other fields of materials science and engineering.

Embodiments of the present disclosure provide a significant step towards more viable and sustainable LMB technologies, paving the way for their widespread application in the EV and other suitable industrial applications. The expected improvements in energy density, cycle stability, and safety have the potential to meet the growing demand for high-performance energy storage solutions, ultimately supporting the transition to a more sustainable and energy-efficient future.

### EXAMPLES

### Synthesis of Metal Nanoparticle Carbon Composites

### Example 1

A slurry containing a metal precursor including Fe(acac)₃, carbon black (CB), polyvinylidene fluoride (PVDF), and N-methyl-2-pyrrolidone (NMP) was cast directly on a Cu or stainless steel foil current collector. The slurry-coated current collector was exposed to laser irradiation to form a metal nanoparticle carbon (M-C) composite. The laser irradiation conditions included a speed of 100 millimeter per second (mm/s), a repetition rate of 250,000 Hz, and a spot diameter of 35 micrometer (μm), with the laser energy fixed at 1 microjoule (μJ).

### Example 2

Example 2 is a M-C composite prepared according to Example 1 except that the metal precursor included Cu(acac)₂ instead of Fe(acac)₃.

### Example 3

Example 3 is a M-C composite prepared according to Example 1 except that the metal precursor included Zn(acac)₂ instead of Fe(acac)₃.

### Characterization of Metal Nanoparticle Carbon Composites

FIG. 6 shows the results of Raman spectroscopy of the M-C composites prepared in Examples 1, 2 and 3 that exhibited increased 2D peaks compared to the original carbon black, indicating the formation of graphitic carbon.

FIGS. 7A, 7B, 7C and 7D are high-resolution transmission electron microscopy (HR-TEM) images of the M-C composites prepared in Example 1. FIGS. 8A, 8B, 8C and 8D are high-resolution transmission electron microscopy (HR-TEM) images of the M-C composites prepared in Example 2. FIGS. 9A, 9B, 9C and 9D are high-resolution transmission electron microscopy (HR-TEM) images of the M-C composites prepared in Example 3. The TEM images show that the metal nanoparticles in the M-C composites prepared in Examples 1, 2 and 3 had a diameter of less than (e.g., at most) 10 nanometer (nm).

FIGS. 10A, 10B and 10C are the results of X-ray photoelectron spectroscopy (XPS) analysis of the M-C composite prepared in Examples 1, 2 and 3, respectively, that confirm the reduction of the metal precursors.

### Example 4

Example 4 is a M-C composite prepared according to Example 1 except that the metal precursor included Al(acac)₃ instead of Fe(acac)₃.

### Example 5

Example 5 is an alloy M-C composite that was prepared according to Example 1 except that two metal precursors Cu(acac)₂ and Ag(acac)₂ were used instead of the metal precursor Fe(acac)₃. FIG. 11 shows a scanning transmission electron microscopy (STEM) image and energy-dispersive X-ray spectroscopy (EDS) elemental maps of the M-C composite prepared in Example 4 including Cu—Ag alloy nanoparticles.

### Electrochemical Performance of Various Metal Nanoparticles-Carbon Composites

### Evaluation Example 1

The electrochemical performance of the M-C composites prepared in Examples 1, 2, 3 and 4 was evaluated with galvanostatic cycling tests at a current density of 1 milliampere per square centimeter (mA/cm²) with an areal capacity of 1 mAh/cm² in a 1 molarity (M) LiTFSI in 1,3-dioxolane and 1,2-dimethoxyethane (DOL-DME) (1:1, v/v) electrolyte with 2 wt % LiNO₃. The evaluation included carbon black (CB) as a control and a AgC composite as a reference. The nucleation overpotential, which indicates the initial barrier for Li plating, was measured during the first cycle and the 20th cycle.

FIG. 12 and FIG. 13 show that nucleation overpotentials for M-C composites including AlC, FeC, CuC, and ZnC during the first cycle were 84.6 mV (millivolt), 66.3 mV, 74.6 mV, and 69.8 mV, respectively, and during the 20th cycle were 34.9 mV, 29.7 mV, 37.3 mV, and 11.8 mV, respectively. These results indicate that the M-C composite including FeC exhibits the lowest nucleation overpotential in both the first and 20th cycles, suggesting a more favorable nucleation process for Li deposition. The M-C composite including ZnC also showed significant reduction in nucleation overpotential by the 20th cycle, indicating improved performance over repeated cycles.

### Evaluation Example 2

The galvanostatic cycling tests described in Evaluation Example 1 were continued and coulombic efficiency (CE) was evaluated after 400 cycles. FIG. 14 shows CE of the M-C composites prepared in Examples 1, 2, 3 and 4 and illustrates stability and reversibility of Li plating/stripping processes.

The M-C composite including FeC had a CE close to 100% throughout 400 cycles, demonstrating excellent stability and efficiency.

The M-C composite including ZnC had a high initial CE that slightly decreased over extended cycles, maintaining close to 100% throughout 250 cycles.

The M-C composite including CuC had a high initial CE that declined gradually to about 80% after 250 cycles.

The CB control exhibited the lowest and most unstable CE and dropped significantly after 150 cycles, indicating poor stability.

These results show that the M-C composites of the present disclosure provide electrochemical performance and stability comparable with a AgC composite. A Li metal battery (LMB) including the M-C composites of the present disclosure may have excellent or suitable electrochemical performance and stability. In some embodiments, the M-C composites including FeC and ZnC may provide high performance and lower or reduced material costs, e.g., when compared to an AgC composite.

### Synthesis and Evaluation of Ag—Ti Nanoparticle Carbon Composite

### Example 6

Example 6 is a Ag—TiC composite (e.g., M-C composite) including Ag—TiC prepared according to Example 1 except that the metal precursor included Ag(acac)₂ and a trace amount of Ti(IV) oxyacetylacetonate (TiO(acac)₂) instead of Fe(acac)₃.

FIG. 15A is the XPS analysis of the Ag—TiC composite showing peaks for elemental Ag metal at about 374.3 and 268.4 electron volt (eV) indicating the reduction of the Ag precursor.

FIG. 15B is the XPS analysis of the Ag—TiC composite showing peaks at about 455, 458.7, 461 and 464.5 eV representing bonds between Ti and C of a titanium-carbon compound (TiC), indicating that TiO(acac)₂ was reduced and formed bonds to carbon.

FIG. 16A and FIG. 16B are HR-TEM images of the Ag—TiC composite showing uniformly formed Ag nanoparticles having a diameter of less than 10 nm encapsulated in the carbon matrix. FIGS. 16C and 16D are HR-TEM images of the Ag—TiC composite showing Ti incorporated on an atomic scale within the carbon matrix and a layer of the titanium-carbon compound (TiC) covering the Ag nanoparticles.

To evaluate the electrochemical performance of the Ag—TiC composite, a series of experiments and analyses were conducted to determine improvements to shielding effect to concentrate Li plating and stripping on Ag nanoparticles, electrical conductivity to reduce resistance in the interlayer, and optimize the interlayer composition and structure to minimize or reduce electrical resistance and enhance Li-ion mobility.

FIG. 17 shows the voltage profiles of half cells with Ag—C, and Ag—TiC composites during the first cycle at a current density of 5 mA/cm² and an areal capacity of 1 mAh/cm². The profiles indicate the influence of Ti content on nucleation overpotential, with higher Ti content leading to higher nucleation overpotential. FIG. 17 shows that in the first cycle, nucleation overpotential increased with higher Ti content of the Ag—TiC composite.

FIG. 18 shows Nyquist plots for the impedance spectra of half cells including Ag—C and Ag—TiC composites. The Rs values, represented by the intercept with the real (horizontal) axis, indicate improved ionic conductivity and better electrode kinetics with Ti incorporation. FIG. 18 shows that the Ag—TiC composite exhibited lower Rs values compared to AgC composites, indicating improved ionic conductivity and better electrode kinetics.

FIG. 19 shows a comparative analysis of the electrochemical performance of half cells using Ag—TiC composites, Ag—C composites, and TiC composites on a copper current collector and a Celgard 2500 separator.

The half cells were tested at a current density of 5 mA/cm² and an areal capacity of 1 mAh/cm² with Celgard 2500 in an electrolyte of 1M LiTFSI in DOL-DME (1:1, v/v) electrolyte with 2 wt % LiNO₃. FIG. 19 shows the superior stability and performance of the Ag—TiC composite compared to TiC and AgC composites. Higher Ti content correlated with higher nucleation overpotential, suggesting that the lithiophobic properties of Ti may increase the energy barrier for Li nucleation. However, despite the higher nucleation overpotential, the cyclic performance of the half-cells improved with the incorporation of Ti into the carbonaceous matrix. This result may be attributed to the combination lithiophobic properties of Ti and C that may concentrate Li around AgNPs, leading to more efficient Li plating and stripping.

According to one or more embodiments, incorporating Ti into the carbonaceous matrix of lithophilic M-NP composites enhances conductivity, reduces electrical resistance, and ensures that Li concentrates on the M-NP, maintaining high CE over extended cycles. By protecting these processes and materials, embodiments of the present disclosure provide efficient and scalable production of advanced interlayers and lithium hosts for high-energy-density ASSBs.

The methods of embodiments of the present disclosure may reduce energy requirements and production time to increase the efficiency of the manufacturing process, and also enhances the overall performance and safety of LMBs produced thereby. The methods of embodiments of the present disclosure may advance the viability and sustainability of LMB technology so it is more accessible for widespread application in the EV and other suitable industrial applications.

Terms such as “substantially,” “about,” and “approximately” are used as relative terms and not as terms of degree, and are intended to account for the inherent deviations in measured or calculated values that would be recognized by those of ordinary skill in the art. They may be inclusive of the stated value and an acceptable range of deviation as determined by one of ordinary skill in the art, considering the limitations and error associated with measurement of that quantity. For example, “about” may refer to one or more standard deviations, or ±30%, 20%, 10%, 5% of the stated value.

Numerical ranges disclosed herein include and are intended to disclose all subsumed sub-ranges of the same numerical precision. For example, a range of “1.0 to 10.0” includes all subranges having a minimum value equal to or greater than 1.0 and a maximum value equal to or less than 10.0, such as, for example, 2.4 to 7.6. Applicant therefore reserves the right to amend this specification, including the claims, to expressly recite any sub-range subsumed within the ranges expressly recited herein.

A battery management system (BMS) device, and/or any other relevant devices or components according to embodiments of the present disclosure described herein may be implemented utilizing any suitable hardware, firmware (e.g., an application-specific integrated circuit), software, or a combination of software, firmware, and hardware. For example, the components of the device may be formed on one integrated circuit (IC) chip or on separate IC chips. Further, the components of the device may be implemented on a flexible printed circuit film, a tape carrier package (TCP), a printed circuit board (PCB), or formed on one substrate. Further, the components of the device may be a process or thread, running on one or more processors, in one or more computing devices, executing computer program instructions and interacting with other system components for performing the functionalities described herein. The computer program instructions are stored in a memory which may be implemented in a computing device using a standard memory device, such as, for example, a random access memory (RAM). The computer program instructions may also be stored in other non-transitory computer readable media such as, for example, a CD-ROM, flash drive, and/or the like. Also, a person of skill in the art should recognize that the functionality of computing devices may be combined or integrated into a single computing device, or the functionality of a particular computing device may be distributed across one or more other computing devices without departing from the scope of the present disclosure.

Example embodiments of the present disclosure have been described, but the present disclosure is not limited thereto. One or more suitable other modifications may be implemented within the scope of the claims, the detailed description of the present disclosure, and the appended drawings, and are also included in the scope of the present disclosure. Accordingly, any modified embodiments may not be understood separately from the technical ideas and aspects of the present disclosure, and the modified embodiments are within the scope of the appended claims and equivalents thereof.

What is claimed is:

1. An interlayer comprising a nanocomposite, a matrix, and a binder,
the nanocomposite comprising nanoparticles and a carbonaceous material,
the nanoparticles comprising metals, metalloids, alloys thereof, compounds thereof, or suitable combinations thereof,
the nanocomposite being a silver-free nanocomposite,
the matrix comprising a bulk carbonaceous material, and
the interlayer being for a lithium metal battery (LMB).

2. The interlayer as claimed in claim 1, wherein the interlayer is for an anodeless all-solid-state battery (ASSB) or an anodeless all-solid-state lithium metal battery (ASSLMB).

3. The interlayer as claimed in claim 1, wherein the nanocomposite is a metal nanoparticle carbon (M-C) nanocomposite and the nanoparticles comprise at least one metal or at least one metal alloy.

4. The interlayer as claimed in claim 3, wherein the nanoparticles comprise at least one of aluminum, antimony, bismuth, cobalt, copper, germanium, gold, iron, molybdenum, nickel, platinum, silicon, tellurium, tin, titanium, tungsten, or zinc.

5. The interlayer as claimed in claim 1, wherein the nanocomposite is a metal nanoparticle titanium-carbon (M-TiC) nanocomposite comprising titanium and the nanoparticles.

6. The interlayer as claimed in claim 5, wherein the M-TiC nanocomposite comprises a titanium-carbon (TiC) compound, the TiC compound being in the matrix and having Ti—C chemical bonds and lithiophobic properties.

7. The interlayer as claimed in claim 6, wherein the nanoparticles comprise a coating, the coating comprising the TiC compound and surrounding at least a portion of a surface of the nanoparticles.

8. The interlayer as claimed in claim 1, wherein an average diameter of the nanoparticles is at least about 5 nanometers (nm).

9. The interlayer as claimed in claim 1, wherein the carbonaceous material comprises amorphous carbon, graphite, graphene, reduced graphene oxide, carbon nanotube, or combinations thereof.

10. The interlayer as claimed in claim 1, wherein the interlayer comprises, based on a total weight of the interlayer:
about 5 wt % to about 95 wt % of the carbonaceous material;
about 0.1 wt % to about 50 wt % of the nanoparticles; and
about 0.01 wt % to about 10 wt % of the binder.

11. The interlayer as claimed in claim 1, wherein a thickness of the interlayer is about 1 micrometer (μm) to about 30 μm.

12. An interlayer comprising a silver titanium-carbon (Ag—TiC) nanocomposite, a matrix, and a binder,
the Ag—TiC nanocomposite comprising silver nanoparticles, a titanium-carbon (TiC) compound, and a carbonaceous material,
the TiC compound having lithiophobic properties, and
the interlayer being for a lithium metal battery (LMB).

13. A lithium metal battery comprising:
a positive electrode;
a negative electrode current collector;
an electrolyte; and
an interlayer comprising the interlayer as claimed in claim 1 and being between the electrolyte and the negative electrode current collector.

14. A method of manufacturing an interlayer comprising:
providing a carbonaceous material, at least one redox active compound, and a binder to form a slurry;
applying the slurry to a current collector; and
irradiating the slurry and providing a nanocomposite comprising nanoparticles,
the interlayer comprising the nanocomposite.

15. The method as claimed in claim 14, wherein the providing of the redox active compound comprises at least one compound comprising a metal, a metalloid, or combinations thereof.

16. The method as claimed in claim 14, wherein the providing of the redox active compound does not include a silver-containing compound.

17. The method as claimed in claim 14, wherein the irradiating of the slurry comprises laser irradiating the slurry.

18. The method as claimed in claim 17, wherein the laser irradiating of the slurry comprises at least one of:
a speed of about 10 millimeter per second (mm/s) to about 1000 mm/s,
a repetition rate of about 50,000 Hz to about 500,000 Hz,
a spot diameter of about 5 micrometer (μm) to about 85 μm, or
a laser energy of about 0.01 microjoule (μJ) to about 100 μJ.

19. A method of operating a lithium metal battery, the method comprising:
providing a lithium metal battery comprising:
a positive electrode;
a negative electrode current collector;
a solid-state electrolyte between the positive electrode and the negative electrode current collector; and
an interlayer as claimed in claim 1 and being between the electrolyte and the negative electrode current collector; and
charging the lithium metal battery to provide a plated anode.

20. The method as claimed in claim 19, wherein the method further comprises discharging the lithium metal battery to remove the plated anode.
